(19) United States
(12) Patent Application Publication
(10) Pub. No.: US 2010/0153984 A1
(43) Pub. Date: Jun. 17, 2010

(54) User Feedback Based Highlights of Recorded Programs

(75) Inventor: Nadav M. Neufeld, Sunnyvale, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/333,826

(22) Filed: Dec. 12, 2008

(51) Int. Cl. H04H 60/32

(52) U.S. Cl. 725/14

(57) ABSTRACT

A television program is recorded by multiple client devices. After feedback regarding playback of the television program by at least a threshold number of other users has been analyzed, a highlight version of the television program is obtained by a client device. The highlight version of the television program is one or more portions of the television program. A user request to playback the highlight version of the television program is received, and in response to this user request, the highlight version of the television program is played back.

### BACKGROUND

Many modern television systems allow users to skip over portions of television programming that they prefer not to watch. This skipping is typically accomplished by allowing the user to select a fast-forward option to go through the portions at a rate that is faster than the normal playback rate. This way of skipping over portions of television programming, however, tends to be very manual in nature, typically requiring numerous manual steps to fast-forward over undesired portions but stop fast-forwarding over desired portions. This can be problematic for users as it can be burdensome and can decrease the user-friendliness of the television systems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a television program is recorded. After feedback regarding playback of the television program by at least a threshold number of other users has been analyzed, a highlight version of the television program is obtained. The highlight version of the television program is one or more portions of the television program. A user request to playback the highlight version of the television program is received, and in response to this user request, the highlight version of the television program is played back.

In accordance with one or more aspects, feedback regarding playback of a television program recorded by the client device is received from each of multiple client devices. After feedback from at least a threshold number of client devices has been received, one or more highlight versions of the television program are generated. At least one of the one or more highlight versions are sent to an additional client device.

### BRIEF DESCRIPTION OF THE DRAWINGS

The same numbers are used throughout the drawings to reference like features.

FIG. 1 illustrates an example system implementing the user feedback based highlights of recorded programs in accordance with one or more embodiments.

FIG. 2 is a flowchart illustrating an example process for user feedback based highlights of recorded programs in accordance with one or more embodiments.

FIG. 3 is a flowchart illustrating an example process for user feedback based highlights of recorded programs in accordance with one or more embodiments.

FIG. 4 illustrates various components of an example client device in accordance with one or more embodiments.

FIG. 5 illustrates an example entertainment and information system in which one or more embodiments of the user feedback based highlights of recorded programs can be implemented.

### DETAILED DESCRIPTION

User feedback based highlights of recorded programs is discussed herein. Generally, television programming is received and recorded by various client devices. Feedback regarding the playback of the television programs is communicated from the client devices to a highlight service. The feedback is based on users' playback of the television programs at those devices, such as which portions of the television programs were watched by the users. From this feedback, a highlight version of the television program is generated and made available to the client devices. This highlight version includes one or more portions of the television program that are determined to be more popular than other portions. This highlight version can be obtained by the client devices so users can playback the highlight version rather than all the portions in the television program. Additionally, the client devices can conserve storage space by storing the highlight version of the program rather than the entire television program.

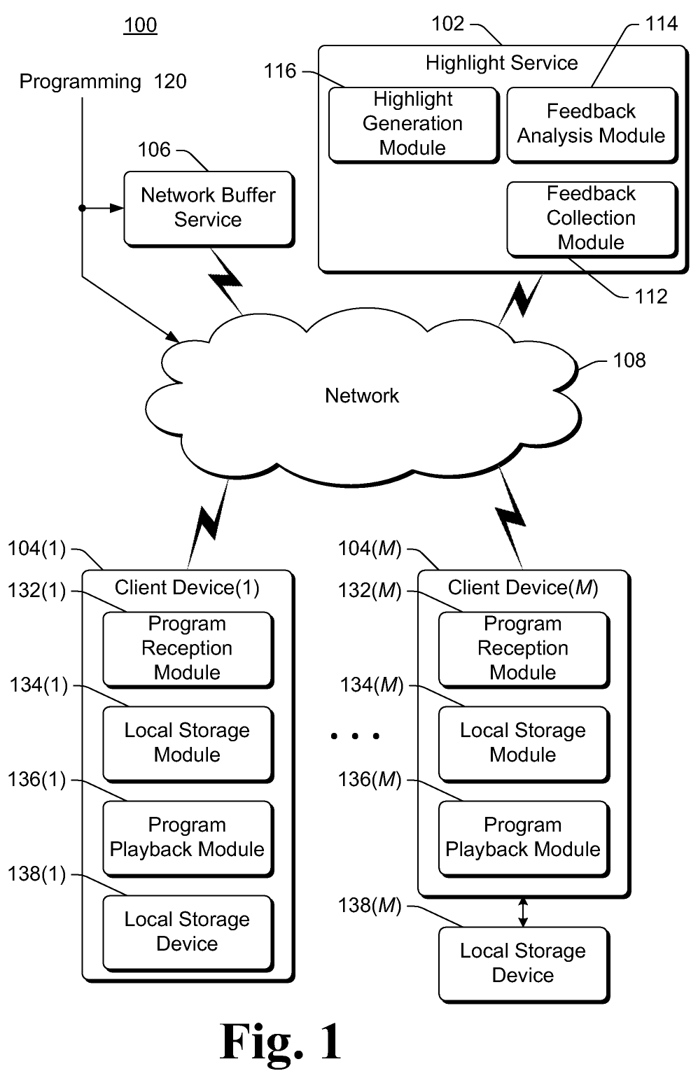

FIG. 1 illustrates an example system 100 implementing the user feedback based highlights of recorded programs in accordance with one or more embodiments. System 100 includes a highlight service 102, one or more (M) client devices 104(1-M), and a network buffer service 106 that can communicate with one another via a network 108. Network 108 can be a variety of different networks, including the Internet, a local area network (LAN), a public telephone network, an intranet, other public and/or proprietary networks, combinations thereof, and so forth. In one or more embodiments network 108 is implemented to include an Internet Protocol (IP)-based network that facilitates programming distribution and data communication among services 102 and 106 and any number of client devices 104. An IP-based network is a network that supports communication among devices using IP, such as IP version 4 (IPv4, such as discussed in IETF RFC 791), as well as other versions such as IP version 6 (IPv6).

Generally, programming 120 is made available to client devices 104 and network buffer service 106. Programming 120 can be made available to each client device 104 and service 106 directly, or alternatively via network 108. Programming 120 includes television programs from one or more sources, such as a satellite operator, a network television operator, a cable operator, and so forth. This programming can be received from the sources via any of a variety of transmission media, such as satellite transmission, radio frequency transmission, cable transmission, and so forth. Programming 120 can include any of a variety of different television programs, such as sitcoms, news broadcasts, documentaries, cartoon shows, movies, and so forth. These programs can optionally include advertisements as well. Any program that can be aired by a source can be included as a television program of programming 120. The airing of a program refers to the transmitting of the program by the source via any transmission media.

Network buffer service 106 receives programming 120 from one or more sources as the programming is aired by the source(s), and stores the aired programming. This programming is then made accessible to client devices 104 after (and/or during) airing of the programming so that the programming can be retrieved and played back by client device 104 and/or stored in a local storage device of client devices 104. This allows a client device 104 to retrieve a previously aired program that was not recorded (or is not stored in its entirety) by device 104. Network buffer service 106 can be implemented as one or more devices (e.g., one or more servers or other computing device). Additionally, although a single network buffer service 106 is illustrated in FIG. 1, alternatively multiple network buffer services 106 can be included in a system 100.

The television programs received as programming 120 are stored temporarily by network buffer service 106. In one or more embodiments, all programs in programming 120 are stored by network buffer service 106 temporarily. Alternatively, service 106 can optionally impose one or more filters to restrict which programs it stores. The duration of the temporary storage provided by network buffer service 106 can vary. For example, the duration can be 48 hours, 72 hours, 1 week, and so forth. It is to be appreciated that the exact duration of this temporary storage can vary by implementation and based on the desires of an operator of service 106.

Each client device 104 can be any of a variety of types of devices, and different client devices 104 can be different types of devices. For example, a client device 104 can be a desktop computer, a mobile station, an entertainment appliance, a television, a portable computer, a television set-top box, a cell or other wireless phone, a gaming system, an automotive computer, and so forth. Thus, client devices 104 may range from a full resource device with substantial memory and processor resources (e.g., personal computers, game consoles) to a low-resource device with limited memory and/or processing resources (e.g., traditional set-top boxes, hand-held game consoles).

Each client device 104 includes a program reception module 132, a local storage module 134, and a program playback module 136. Program reception module 132 receives programming 120 via network 108, or alternatively directly from a programming source or other content provider. Program reception module 132 can also retrieve programs, or portions thereof, from network buffer service 106. Program reception module 132 can thus obtain from service 106 portions of a television program that are not included in a highlight version of the program, as discussed in more detail below.

Local storage module 134 manages the storage of programs on a local storage device of client device 104. In one or more embodiments this local storage device is included as part of client device 104 (e.g., an internal disk drive of client device 104). An example of such a local storage device is shown as storage device 138(1). Alternatively, this local storage device can be coupled to client device 104, such as via a bus (e.g., an IEEE 1394 bus, a universal serial bus (USB), etc.), via a local network (e.g., a LAN), and so forth. An example of such a local storage device is shown as storage device 138(M). Programs that are received by program reception module 132 are stored in the local storage device 138 by local storage module 134.

Program playback module 136 manages the playback of television programs by client device 104. Client device 104 can include display and/or audio playback components via which programs are played back, or alternatively client device 104 can output a signal to one or more other components or devices which in turn can display and/or audibly playback the programs. The video content of programs can be played back on any type of television, monitor, LCD, projector, or similar television-based display system that renders video and/or image data. The audio content of programs can be played back on any type of television, stereo, or similar television-based audible playback system that renders audio data. The programs played back by program playback module 136 can be programs retrieved from a local storage device 138 by local storage module 134. Additionally, the programs played back by module 136 can also be retrieved from other components or devices, such as from a programming source or other content distributor as they are received. Playback module 136 can playback programs that have been received in their entirety, as well as portions of programs (e.g., one part of a program can be played back while one or more other parts of the program are being received).

Users can input requests to client devices 104 for programs to be played back in a variety of different manners. In one or more embodiments, a listing of recorded programs that are stored on local storage device 138 and that can be played back is displayed to the user. In addition to, or in place of, the recorded programs stored on local storage device 138, the listing of programs can include programs that are stored at network buffer service 106 and that can be retrieved and played back. The user can navigate through this listing in any of a variety of conventional manners (e.g., using directional keys on a remote control device) to select a particular program that he or she desires to have played back. Alternatively, such requests can be input in other manners, such as selection of a program from a drop-down menu, inputting text identifying the program, and so forth. Additionally, requests can optionally be forwarded to client device 104 from another device. For example, a user of a handheld computing device can send a request to client device 104 to have a particular program played back.

Additionally, program playback module 136 can playback a highlight version of a television program. The highlight version can be played back in response to a user request to playback the highlight version, or alternatively in response to a request from another component or module. The highlight version of a program is one or more portions of the program that are determined to be the “highlights” of that program, and are the one or more portions that are determined to be the most popular based on user feedback. The portions that are selected are based on feedback regarding playback of the television program that is received from users of the various client devices 104.

During playback of a television program at a client device 104, or a highlight version of a television program, various feedback regarding playback of the television program is collected by program playback module 136. This collected feedback is sent to highlight service 102 for generation of one or more highlight versions of the television program as discussed in more detail below. The feedback collected by module 136 can take a variety of different forms, and generally is feedback regarding how the program was played back. Examples of this feedback that is collected include user selection of a fast-forward or other skip option, a fast-forward or other playback speed selected by the user, an amount of the program that the user selected to skip over, user selection of a rewind option, a number of times different portions of the program are played back (e.g., repeated rewinding and replaying of a particular portion), a user selection of an option indicating he or she liked or disliked a particular portion, and so forth.

In one or more embodiments, the collection of this feedback and/or the sending of the feedback to highlight service 102 is performed with the consent of the user of client device 104. This can be performed in an opt-in manner, where the feedback is collected and/or sent only after the user has opted into the feedback collection and/or sending. Alternatively, this can be performed in an opt-out manner, where the feedback is collected and/or sent unless the user requests that no feedback collection and/or sending be performed. This user consent can be provided by the user in a variety of different manners, such as via a UI presented to the user requesting his or her consent, via a preference value set by the user indicating his or her consent (or lack thereof), and so forth.

Highlight service 102 includes a feedback collection module 112, a feedback analysis module 114, and a highlight generation module 116. Highlight service 102 can be implemented by one or more devices, such as one or more server or other computing devices. The modules 112, 114, 116 can be implemented on the same device, or alternatively on different devices.

For each of multiple television programs, feedback collection module 112 receives feedback regarding how the program was played back from various client devices 104. This feedback can be received and maintained anonymously, so no record of a particular user's playback is maintained by service 102. This feedback is the feedback that was collected by program playback module 136 as discussed above.

Feedback analysis module 114 receives the feedback from collection module 112, and analyzes the feedback for each television program. This analysis of the feedback for a particular television program identifies which portions of that television program were more popular than which other portions. This analysis is then used by highlight generation module 116 to generate one or more highlight versions of the television program.

The feedback analysis and highlight version generation discussed herein is based on portions of the television program. These portions can be identified in a variety of different manners. In one or more embodiments, the portions are fixed portions of the television program. For example, the television program can be separated into 1-second or ½-second portions. In other embodiments, the portions are variable portions based on the feedback itself. For example, if the feedback indicates that the television program is typically fast-forwarded by users from a location 5.67 seconds into the program to a location 31.28 seconds into the program, then a portion of the program can be defined as the program from 5.67 seconds to 31.28 seconds into the program. By way of another example, if the feedback indicates that the television program is typically rewound at a location 10 minutes and 32.25 seconds into the program to a location 9 minutes and 18.75 seconds into the program, then a portion of the program can be defined as the program from 9 minutes and 18.75 seconds to 10 minutes and 32.25 seconds into the program.

It should be noted that the beginning and ending locations for the portions can optionally change over time. Initial beginning and ending locations for the portions can be determined based on initial feedback that is received by feedback collection module 112. Over time as additional feedback is received from users watching the television program, as well as users watching one or more highlight versions of the television program, the beginning and ending locations can be adjusted. For example, assume that the initial feedback indicates that the television program is typically rewound at a location 10 minutes and 32.25 seconds into the program to a location 9 minutes and 18.75 seconds into the program. However, over time further assume that it is found users typically rewind a little bit further, such as to 9 minutes and 18.25 seconds into the program. Based on this additional feedback, the portion can be redefined to be the program from 9 minutes and 18.25 seconds to 10 minutes and 32.25 seconds into the program.

Based on the collected feedback, analysis module 114 also assigns a score to each of the portions of the television program. These scores associated with the portions allows the more popular portions to be identified. For example, more popular portions can have higher scores than less popular portions. The scores can be assigned in a variety of different manners. In one or more embodiments, each portion of the television program begins at the same score, such as a score of zero. For each portion of the program, the score of that portion is incremented if the collected feedback indicates that the portion is popular, and the score of that portion is decremented if the collected feedback indicates that the portion is not popular. The particular amount by which the score is incremented or decremented can also vary based on the particular feedback for the portion.

For example, each time a portion is played back at a normal rate the score can be incremented by a first amount (e.g., a value of one), and each time the portion is rewound and replayed the score can be increased by a larger second amount (e.g., a value of three). By way of another example, each time the portion is fast-forwarded over at a rate two times the normal playback rate the score can be decremented by a particular amount (e.g., a value of one), and each time the portion is fast-forwarded over at a rate ten times the normal playback rate the score can be decremented by a larger amount (e.g., a value of three).

In addition to, or in place of, using these scores, feedback analysis module 114 can use a variety of other algorithms or rules to analyze the collected feedback. Examples of such rules or algorithms include the following:
The number of times playback of particular portions was skipped over. The larger the number of times playback of a particular portion is skipped over, the less popular that portion can be deemed to be.
A percentage or ratio of the number of times playback of particular portions was skipped over relative to the number of times the television program was played back. The larger the percentage of times playback of the particular portion is skipped over, the less popular that portion can be deemed to be.
A percentage or ratio of the number of times playback of the television program has started relative to the number of times the television program has been recorded. A particular percentage or ratio can be used in determining when a highlight version of the television program can be generated, as discussed in more detail below.
The distribution of the points of time in the television program in which fast-forwarding (or other skips) or rewinding occurred. As more feedback is received, the particular points in time at which the fast-forwarding or rewinding occurred can be used to refine the portion beginning and ending locations.
The number of times the portions of the content have been replayed. The larger the number of times a portion is replayed, the more popular that portion can be deemed to be.

Additionally, it should be noted that the feedback regarding playback of the television program collected by module 112 can be weighted equally for all users, or alternatively can be weighted differently. If weighted differently, different users can be assigned different weights based on various criteria. The weights can be assigned by feedback collection module 112, program playback module 136, or alternatively another component or module. Examples of criteria that can be used to assign weights include an amount of previous feedback provided by the user (e.g., higher weighting for more feedback), how closely the user's playback matches the highlight version generated by module 116 (e.g., higher weighting for the user viewing only the portions in the highlight version and not other portions of the television program), how frequently the user plays back particular programs (e.g., if a user frequently plays back football games, the user's weight for a television program that is a football game can be higher), and so forth. It is to be appreciated that the weight for a user can change over time as more feedback is collected. It is also to be appreciated that the same user can have different weights for different types of television programs (e.g., one weight for sports programs, another weight for talk show programs).

These different weights can be used to alter how much a particular user's feedback impacts the analysis performed by module 114. By way of example, assume that a particular playback action (such as fast-forward) for a particular portion of the program would normally increment a score of the portion by a value of two. If the user performing that playback action had a weight of 0.5, then the score would only be incremented by a value of one if the user were to perform that action for that portion. If the user performing that playback action had a weight of 2, then the score would be incremented by a value of four if the user were to perform that action for that portion.

Highlight generation module 116 generates one or more highlight versions of a television program based on the analysis performed by feedback analysis module 114. For a television program, highlight generation module 116 identifies the most popular portions of that program using the results of the analysis performed by module 114. The particular television programs for which highlight versions are generated can be identified in different manners. In one or more embodiments, one or more highlight versions are generated for each television program in programming 120. Alternatively, one or more highlight versions can be generated only for particular types of programs, such as programs exceeding a particular length, sports event programs, news programs, and so forth. In other alternatives, another component or module notifies highlight service 102 of the television programs for which one or more highlight versions are to be generated.

Highlight generation module 116 can generate a highlight version of a television program using a variety of different techniques. In one or more embodiments, module 116 generates a highlight version including portions of the television program having an associated score that exceeds a threshold value. The threshold value can be identified in different manners, such as by a system administrator, by a user of client device 104, by a provider of the television program, via a configuration setting in module 116, by another component or module, and so forth. This threshold value can be a fixed value (e.g., a score of 200), or alternatively can be a variable value based on the scores received in the feedback (e.g., a value in the top 15% of scores). It is to be appreciated that the duration of such a highlight version can vary and is dependent on the threshold value that is set.

In other embodiments, module 116 generates a highlight version that is a particular length. Module 116 selects portions of the television program to include in the highlight version based on this length, with the portions having the highest associated scores being selected until the length is satisfied. This particular length can be identified in different manners, such as by a system administrator, by a user of client device 104, by a provider of the television program, via a configuration setting in module 116, by another component or module, and so forth. The length can be a fixed value (e.g., 15 minutes), or alternatively can be a variable value based on the length of the television program (e.g., 20% of the length of the entire television program).

Highlight generation module 116 can generate a single highlight version for a television program, or alternatively can generate multiple highlight versions of the same television program. The number of highlight versions to generate can be identified in different manners, such as by a system administrator, by a provider of the television program, via a configuration setting in module 116, based on the length of the television program, by another component or module, and so forth. Each of the different highlight versions can be generated using the same technique but different threshold or length values (e.g., one highlight version may have a length of 20% of the length of the entire television program, whereas another highlight version may have a length of 40% of the length of the entire television program). Alternatively, different highlight versions can be generated using different techniques (e.g., one highlight version may include the portions of the program associated with a score in the top 15% of scores, whereas another highlight version may be the highest-scoring portions that are combined to have a length of 15 minutes).

Additionally, the highlight versions generated by highlight generation module 116 can be identified in a variety of different forms. In one or more embodiments, a highlight version of a television program is identified by a list of identifiers indicating the various portions of the television program that are included in that particular highlight version. These portions can be, for example, a list of times of portions of the program (e.g., seconds 1-5, 17-23, 57-102, etc. of the program). Alternatively other identifiers of portions can be used, such as offsets into the program, other identifiers of frames of the video content in the program, and so forth. In such embodiments, the highlight version that is generated is identified by a list of portions of the television program that are to be played back as the highlights of the television program.

In other embodiments, the highlight version of the television program is identified by the subset of the audio/video data that is the television program. Thus, rather than identifying the highlight version with a listing of portions, the highlight version can be identified with the actual portions. In such embodiments, module 116 can create a new highlights program by creating a new file that includes the portions of the television program that are to be included in the highlight version. This highlight version is thus a stand-alone version that can be distributed and played back independently of the television program.

Highlight generation module 116 generates the highlight version of a television program after feedback regarding playback of the television program by at least a threshold number of other users has been received. This threshold number of other users can be a fixed number (e.g., at least 1000 other users), or alternatively a variable number based on the number of users that have recorded the television program (e.g., at least 1% of the number of users that have recorded the program have played back the program).

Once one or more highlight versions of a television program are generated, the one or more highlight versions can be obtained and played back by client devices 104. A highlight version playback option can be made available for selection by the user, such as an on-screen menu item or button, a “highlight” key or button on client device 104 or a remote control device in communication with client device 104, an audible input by the user, and so forth. If multiple highlight versions of a program have been generated, then the user can further select a particular one of those multiple highlight versions. The particular version can be inherent in the highlight version playback option selected by the user (e.g., the different versions can be presented to the user for selection, such as “15-minute highlight” or “30-minute highlight”). Alternatively, after the user has selected playback of a highlight version, the user can next input a request for the particular one of multiple versions he or she desires to have played back.

The highlight version that is generated by module 116 is communicated to program reception modules 132 of client devices 104. The manner in which the highlight version is communicated to modules 132 can vary based on the manner in which the highlight version is identified (e.g., a listing of identifiers indicating the various portions of the television program that are included in the highlight version can be communicated to modules 132, the actual portions that are included in the highlight version can be communicated to modules 132, and so forth). After generating the highlight version, module 116 can automatically communicate the highlight version to modules 132. Alternatively, module 132 can request and receive the highlight version from module 116 when desired, such as when a request to playback a highlight version of the television program is received by a user of client device 104.

Feedback regarding playback of a highlight version of a television program is collected by program playback module 136 and returned to feedback collection module 112. Thus, highlight service 102 collects feedback regarding playback of the entire television program as well as playback of the highlight version of the television program. This allows an initially generated highlight version to be refined based on playback of the highlight version. For example, assume that the initially generated highlight version of the television program identified a portion beginning at 35 minutes, 12.25 seconds into the program. Further assume that feedback regarding playback of the highlight version indicated that users typically rewound the program a little bit from this identified beginning location to 35 minutes, 12.08 seconds into the program. Highlight generation module 116 can refine the highlight version to have a beginning location for this portion at 35 minutes, 12.08 seconds into the program. This refined highlight version can be subsequently sent to client devices 104 rather than the initial highlight version. Service 102 can automatically send this refined highlight version to client devices 104 that previously obtained the highlight version of the television program, allowing those devices 104 to replace the previous highlight version with this refined highlight version. Alternatively, service 102 can send this refined highlight version in response to any subsequent requests for the highlight version from client devices 104.

In one or more embodiments, upon receipt of a highlight version of a program, program reception module 132 saves the highlight version in local storage device 138. Alternatively, the highlight version need not be stored in device 138, but rather maintained by client device 104 temporarily for playback of the highlight version, then subsequently obtained again if playback of the highlight version is subsequently requested.

Local storage module 134 can optionally use the highlight version of a television program to conserve storage space in local storage device 138. In one or more embodiments, local storage module 134 stores only the portions of a television program that are in the one or more highlight versions in device 138. Other portions of the television program that are not in a highlight version are deleted from device 138. Thus, rather than storing the entire television program, only the portions in one of the highlight versions are stored. If a highlight version is identified by a list identifying portions of the television program, then those identified portions of the television program are stored in device 138 but other portions of the television program are not stored. If a highlight version is a standalone file, then only that file is stored in device 138 and the television program itself is deleted.

Local storage module 134 can identify which television programs are stored in their entirety and which have only their highlight versions stored in a variety of different manners. In one or more embodiments, all television programs are stored in their entirety until storage device 138 is filled to a threshold amount with television programs. Once at that threshold amount, one or more of the previously recorded television programs are selected to be stored in highlight version only. The particular programs can be selected in different manners, such as being selected by a user, being selected chronologically based on when they were recorded, being selected alphabetically by title, being selected based on length, being selected randomly, and so forth.

Alternatively, local storage module 134 can be configured to store certain television programs in their entirety, and only highlight versions of other television programs. This configuration can be set, for example, by a user of client device 104, by a system administrator, and so forth. This configuration can indicate that for specific television programs only a highlight version is to be stored, or alternatively can indicate that for specific types of television programs only a highlight version is to be stored (such as programs exceeding a particular length, sports programs, news programs, and so forth).

Situations can arise where only a highlight version of a television program is stored in device 138, but a user requests playback of a portion of the program that is not in the highlight version. For example, the user can request playback of the entire television program rather than the highlight version, or can request to fast-forward or rewind to a portion that is not included in the highlight version. In such situations, program reception module 132 obtains the portions that are not in the highlight version from network buffer service 106 or alternatively from another source. Thus, storage space on client devices 104 can be conserved by storing only the highlight versions of television programs, but other portions of the programs that are not in the highlight versions can be obtained and played back when requested by the user.

In one or more embodiments, the same highlight versions of a television program are played back for all users. In other embodiments, different users can be grouped together differently, and different highlight versions can be generated for these different groups. Feedback collection module 112 can maintain different groups of users based on a variety of different criteria, such as user-identified interests, user demographics, other user-provided information, and so forth. Users can be assigned to different groups based on these criteria, and the feedback from the users in these different groups is collected together. A separate analysis can be performed by module 114 for each of these different groups to identify portions of the television program that were more popular than other portions to the users in those different groups. Highlight generation module 116 can use these different analyses to generate different highlight versions for the different groups. Feedback analysis module 114 can also include an “all users” in which feedback from all users is analyzed (regardless of which groups the users belong to), and module 116 can generate one or more highlight versions based on this feedback from all users.

This grouping together can be an additional service or feature that users can optionally join. Users that join the group get the benefit of having highlight versions that are more tailored to similar types of users, but users can proceed anonymously if they so choose. Thus, the user can choose whether to divulge information regarding his or her interests, demographic information, and so forth.

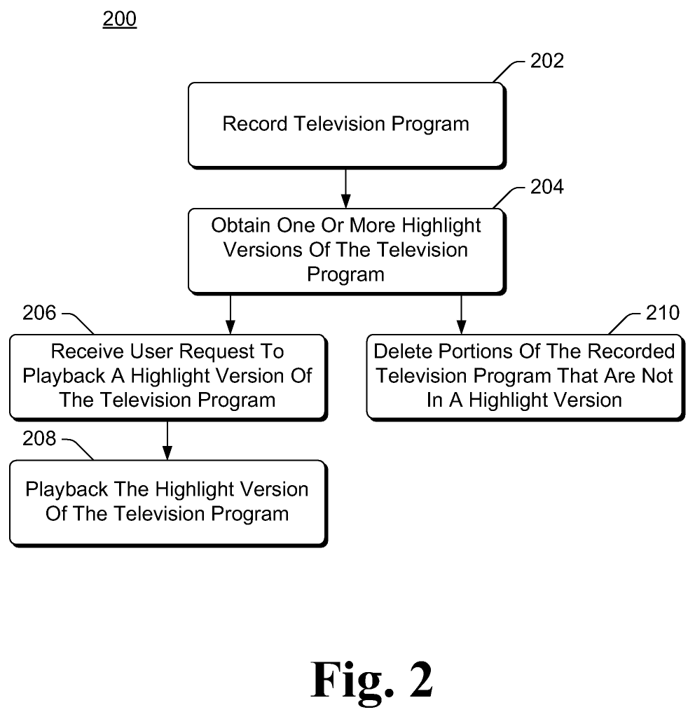

FIG. 2 is a flowchart illustrating an example process 200 for user feedback based highlights of recorded programs in accordance with one or more embodiments. Process 200 is carried out by a client device, such as a device 104 of FIG. 1, and can be implemented in software, firmware, hardware, or combinations thereof. Process 200 is an example process for user feedback based highlights of recorded programs; additional discussions of user feedback based highlights of recorded programs are included herein with reference to different figures.

In process 200, an aired television program is recorded (act 202). The television program can be aired in a variety of different manners, as discussed above.

Additionally, one or more highlight versions of the television program are obtained (act 204). As discussed above, these one or more highlight versions are obtained after feedback regarding playback of the television program (and optionally one or more highlight versions of the program) has been analyzed.

A user request to playback a highlight version of the television program can also be received (act 206). If there are multiple highlight versions of the television program, this request in act 206 can also include an indication of a particular one of the multiple highlight versions of the television program.

In response to the user request to playback a highlight version of the television program, the requested highlight version of the television program is played back (act 208).

Additionally, portions of the recorded television program that are not in a highlight version can be deleted (act 210). The client device can thus maintain the recorded portions of the television program that are in the highlight version of the television program, but not other portions.

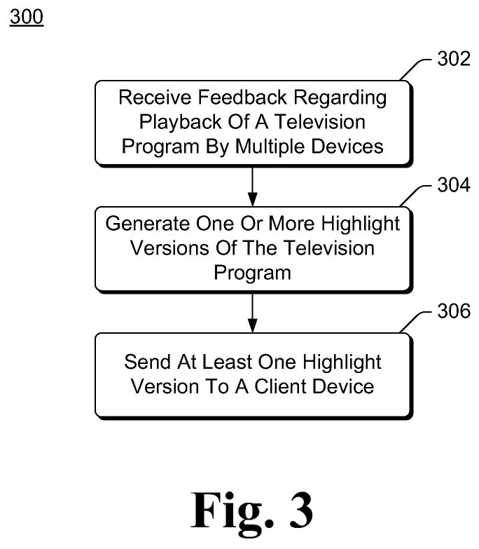

FIG. 3 is a flowchart illustrating an example process 300 for user feedback based highlights of recorded programs in accordance with one or more embodiments. Process 300 is carried out by a highlight service, such as a service 102 of FIG. 1, and can be implemented in software, firmware, hardware, or combinations thereof. Process 300 is an example process for user feedback based highlights of recorded programs; additional discussions of user feedback based highlights of recorded programs are included herein with reference to different figures.

In process 300, feedback regarding playback of a television program recorded by multiple client devices is received (act 302). This feedback can also include feedback regarding playback of a highlight version of the television program, as discussed above.

One or more highlight version of the television program are generated (act 304) after feedback from at least a threshold number of client devices has been received. The number of highlight versions, and the manner in which they are generated, can vary as discussed above.

At least one highlight version of the television program is sent to an additional client device (act 306). This additional client device can be one of the multiple devices from which feedback was received in act 302, or alternatively a different device.

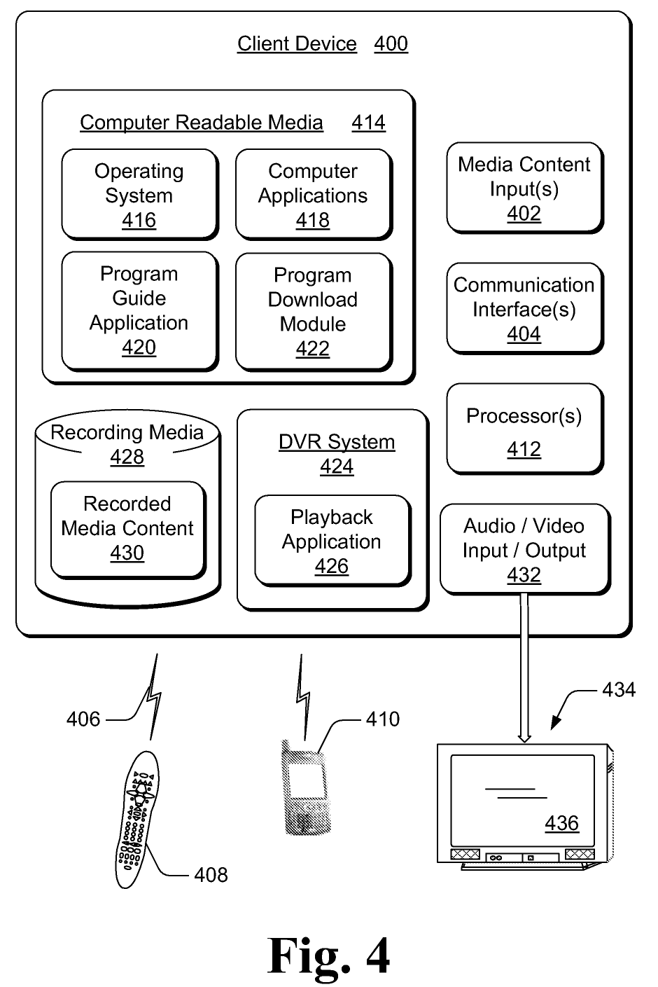

FIG. 4 illustrates various components of an example client device 400 that can be implemented as any form of a computing, electronic, or television client device to implement embodiments of the user feedback based highlights of recorded programs. For example, client device 400 can be implemented as any of the client devices 104(1-A) shown in FIG. 1. In various embodiments, client device 400 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Client device 400 includes one or more media content inputs 402 that may include Internet Protocol (IP) inputs over which streams of media content are received via an IP-based network. Client device 400 further includes communication interface(s) 404 that can be implemented as any one or more of a serial and/or parallel interface, a wireless interface, any type of network interface, a modem, and as any other type of communication interface. A wireless interface enables client device 400 to receive control input commands 406 and other information from an input device, such as from remote control device 408, a portable computing-based device (such as a cellular phone) 410, or from another infrared (IR), 802.11, Bluetooth, or similar RF input device.

A network interface provides a connection between client device 400 and a communication network by which other electronic and computing devices can communicate data with device 400. Similarly, a serial and/or parallel interface provides for data communication directly between client device 400 and the other electronic or computing devices. A modem facilitates client device 400 communication with other electronic and computing devices via a conventional telephone line, a DSL connection, cable, and/or other type of connection.

Client device 400 also includes one or more processors 412 (e.g., any of microprocessors, controllers, and the like) which process various computer-executable instructions to control the operation of device 400, to communicate with other electronic and computing devices, and to implement embodiments of the user feedback based highlights of recorded programs. Client device 400 can be implemented with computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 414 provides data storage mechanisms to store various information and/or data such as software applications and any other types of information and data related to operational aspects of client device 400. For example, an operating system 416 and/or other computer applications 418 can be maintained as software applications with the computer-readable media 414 and executed on processor(s) 412 to implement embodiments of the user feedback based highlights of recorded programs.

Client device 400 can also include a program guide application 420 that is implemented to process program guide data and generate program guides for display. A program guide enables a viewer to navigate through an onscreen display and locate various media content such as broadcast programs, recorded programs, video-on-demand programs and movies, interactive game selections, network-based applications, and other media content of interest to the viewer. Client device 400 can also include a program download module 422 (shown as a software module in this example) to facilitate aspects of the user feedback based highlights of recorded programs described herein. For example, module 422 can facilitate retrieval of previously aired programs from a network buffer service (such as service 106 of FIG. 1).

Client device 400 can also include a DVR system 424 with playback application 426, and recording media 428 to maintain recorded media content 430 that client device 400 downloads (or otherwise receives) and/or records. Further, client device 400 may access or receive additional recorded media content that is maintained with a remote data store (not shown). Client device 400 may also receive media content from a video-on-demand server, or media content that is maintained at a broadcast center or content distributor that distributes the media content to subscriber sites and client devices. The playback application 426 is a video control application that can be implemented to control the playback of media content (e.g., analogous to module 136 of FIG. 1), the recorded media content 430, and/or other video-on-demand media content, music, and any other audio, video, and/or image media content which can be rendered and/or displayed for viewing.

Client device 400 also includes an audio and/or video output 432 that provides audio and/or video data to an audio rendering and/or display system 434. The audio rendering and/or display system 434 can include any devices that process, display, and/or otherwise render audio, video, and image data. Video signals and audio signals can be communicated from client device 400 to a display device 436 via an RF (radio frequency) link, S-video link, composite video link, component video link, DVI (digital video interface), analog audio connection, or other similar communication link. Alternatively, the audio rendering and/or display system 434 can be implemented as integrated components of the example client device 400. Client device 400 along with the audio rendering and/or display system 434 is an example of a viewing system that can be implemented in a household viewing area for viewing television programs and/or receiving other television media content.

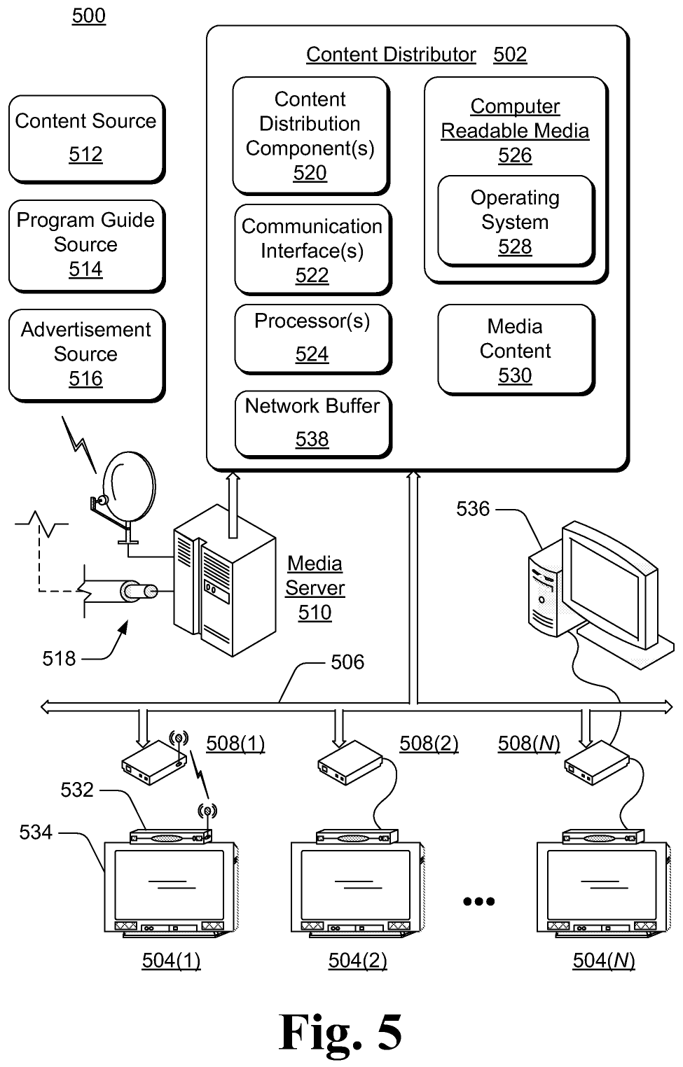

FIG. 5 illustrates an example entertainment and information system 500 in which embodiments of the user feedback based highlights of recorded programs can be implemented. System 500 facilitates the distribution of media content, program guide data, and advertising content to multiple viewers and to multiple viewing systems. System 500 includes a content distributor 502 and any number “N” of client systems 504(1-N) each configured for communication via a communication network 506. Each client system 504(1-N) is an example of the client devices 104(1-M described with reference to FIG. 1. Each of the client systems 504(1-N) can receive data streams of media content, program content, program guide data, advertising content, closed captions data, and the like from content server(s) of the content distributor 502 via the communication network 506.

The communication network 506 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 506 can be implemented using any type of network topology and any network communication protocol, and can be represented or otherwise implemented as a combination of two or more networks. A digital network can include various hardwired and/or wireless links 508(1-N), routers, gateways, and so on to facilitate communication between content distributor 502 and the client systems 504(1-N).

System 500 includes a media server 510 that receives media content from a content source 512, program guide data from a program guide source 514, and advertising content from an advertisement source 516. In one or more embodiments, the media server 510 represents an acquisition server that receives the audio and video media content from content source 512, an EPG server that receives the program guide data from program guide source 514, and/or an advertising management server that receives the advertising content from the advertisement source 516.

The content source 512, the program guide source 514, and the advertisement source 516 control distribution of the media content, the program guide data, and the advertising content to the media server 510 and/or to other servers. The media content, program guide data, and advertising content can be distributed via various transmission media 518, such as satellite transmission, radio frequency transmission, cable transmission, and/or via any number of other wired or wireless transmission media. In this example, media server 510 is shown as an independent component of system 500 that communicates the program content, program guide data, and advertising content to content distributor 502. In an alternate implementation, media server 510 can be implemented as a component of content distributor 502.

Content distributor 502 is representative of a headend service in a content distribution system, for example, that provides the media content, program guide data, and advertising content to multiple subscribers (e.g., the client systems 504(1-N)). The content distributor 502 can be implemented as a satellite operator, a network television operator, a cable operator, and the like to control distribution of media content, program and advertising content, such as movies, television programs, commercials, music, and other audio, video, and/or image content to the client systems 504(1-N). This content distributed by content distributor 502 can be programming 120 of FIG. 1.

Content distributor 502 includes various content distribution components 520 to facilitate media content processing and distribution, such as a subscriber manager, a device monitor, and one or more content servers. The subscriber manager manages subscriber data, and the device monitor monitors the client systems 504(1-N) (e.g., and the subscribers), and maintains monitored client state information.

Although the various managers, servers, and monitors of content distributor 502 (to include the media server 510 in one or more embodiments) are described as distributed, independent components of content distributor 502, any one or more of the managers, servers, and monitors can be implemented together as a multi-functional component of content distributor 502. Additionally, any one or more of the managers, servers, and monitors described with reference to system 500 can implement features and embodiments of the user feedback based highlights of recorded programs.

The content distributor 502 includes communication interface(s) 522 that can be implemented as any type of interface to communicate and receive data from client devices of the television system. The content distributor 502 also includes one or more processors 524 (e.g., any of microprocessors, controllers, and the like) which process various computer-executable instructions to control the operation of content distributor 502. The content distributor 502 also includes a network buffer 538 that operates analogous to network buffer service 106 of FIG. 1, temporarily storing programs received from content source 512 (e.g., via media server 510). The content distributor 502 can be implemented with computer-readable media 526 which provides data storage to maintain software applications such as an operating system 528 and media content 530 for distribution to the client systems 504(1-N).

The client systems 504(1-N) can each be implemented to include a client device 532 and a display device 534 (e.g., a television, LCD, and the like). A client device 532 of a respective client system 504 can be implemented in any number of embodiments, such as a set-top box, a digital video recorder (DVR) and playback system, an appliance device, a gaming system, and as any other type of client device that may be implemented in an entertainment and information system. In an alternate embodiment, client system 504(N) is implemented with a computing device 536 as well as a client device. The computing device 536 is an example of a connected data store that can record and maintain media content for a client device. Additionally, any client device 532 of a respective client system 504 can implement features and embodiments of the user feedback based highlights of recorded programs as described herein.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer-readable memory devices, further description of which may be found with reference to FIGS. 4 and 5. The features of the user feedback based highlights of recorded programs techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a device, the method comprising:
recording a television program;
obtaining, after feedback regarding playback of the television program by at least a threshold number of other users has been analyzed, a highlight version of the television program, the highlight version of the television program being one or more portions of the television program;
receiving a user request to playback the highlight version of the television program; and
playing back, in response to the user request, the highlight version of the television program.

2. A method as recited in claim 1, the receiving comprising receiving a user request to playback one of multiple highlight versions of the television program, and the playing back comprising playing back the requested one of the multiple highlight versions of the television program.

3. A method as recited in claim 1, further comprising
identifying an additional one or more portions of the television program that are not in the highlight version of the television program; and
deleting the additional one or more portions from the television program recorded by the device.

4. A method as recited in claim 3, further comprising:
receiving, after deleting the additional one or more portions, a request to playback one of the additional one or more portions; and
obtaining, from a network buffer service, the one of the additional one or more portions.

5. A method as recited in claim 1, the feedback regarding playback of the television program including feedback regarding playback of the highlight version of the television program.

6. A method as recited in claim 1, wherein different weights are assigned to different users, and wherein the analyzing of the feedback regarding playback of the television program comprises using the different weights in identifying the one or more portions of the television program that are included in the highlight version.

7. A method as recited in claim 1, further comprising:
receiving an additional highlight version of the television program to replace the highlight version of the television program, the additional highlight version being generated based on additional feedback regarding playback of the television program and playback of the highlight version; and
replacing the highlight version of the television program with the additional highlight version of the television program.

8. A method as recited in claim 1, the highlight version of the television program being identified by a listing of identifiers of the one or more portions.

9. A method as recited in claim 1, the highlight version of the television program comprising the one or more portions of the television program.

10. A method as recited in claim 1, wherein the threshold number of client devices is based at least in part on a number client devices that recorded the television program.

11. A method implemented in a device, the method comprising:
receiving, from each of multiple client devices, feedback regarding playback of a television program recorded by the client device;
generating, after feedback from at least a threshold number of client devices has been received, one or more highlight versions of the television program; and
sending to an additional client device, at least one of the one or more highlight versions.

12. A method as recited in claim 11, wherein the additional client device is one of the multiple client devices.

13. A method as recited in claim 11, wherein the feedback includes feedback from one or more users watching the television program and from an additional one or more users watching a highlight version of the television program.

14. A method as recited in claim 11, wherein the sending comprises sending, for each of the one or more highlight versions, an indication of the one or more portions of the television program that are included in the highlight version so that the client device can store only the one or more portions rather than all portions of the television program.

15. A method as recited in claim 11, wherein the sending comprises sending a list identifying one or more portions of the television program that are included in the highlight version.

16. A method as recited in claim 11, wherein the sending comprises sending one or more portions of the television program as the highlight version.

17. A method as recited in claim 11, wherein the threshold number of client devices is based at least in part on a number of the multiple client devices that recorded the television program.

18. A method as recited in claim 11, wherein different weights are assigned to different users, and wherein the generating comprises using the different weights in identifying one or more portions of the television program that are included in each of the one or more highlight versions of the television program.

19. One or more computer-readable media having stored thereon multiple instructions that, when executed by one or more processors of a device, cause the one or more processors to:
record a television program;
obtain, after feedback regarding playback of the television program by at least a threshold number of other users has been analyzed, multiple highlight versions of the television program, each of the multiple highlight versions of the television program being one or more portions of the television program;
delete one or more portions of the television program that are not included in one of the multiple highlight versions of the television program;
receive a user request to playback one of the multiple highlight versions of the television program; and
playback, in response to the user request, the requested one of the multiple highlight versions of the television program.

20. One or more computer-readable media as recited in claim 19, the multiple instructions further causing the one or more processors to:
receive, after deleting the one or more portions, a request to playback one of the one or more portions; and
obtain, from a network buffer service, the one of the one or more portions.
